(19) United States
(12) Patent Application Publication
(10) Pub. No.: US 2006/0261269 A1
(43) Pub. Date: Nov. 23, 2006

(54) Method for high-resolution 3d reconstruction

(76) Inventor: Ulf Skoglund, Stockholm (SE)

Correspondence Address: YOUNG & THOMPSON, 745 SOUTH 23RD STREET, 2ND FLOOR, ARLINGTON, VA, 22202, US

(21) Appl. No.: 10/544,186

(22) PCT Filed: Jan. 22, 2004
(86) PCT No.: PCT/SE04/00075

§ 371 Date: May 24, 2006

(30) Foreign Application Priority Data
Jan. 30, 2003 (US) 60319915
Jan. 30, 2003 (SE) 03002223-5

(51) Int. Cl. G21K 7/00

(52) U.S. Cl. 250/311

(57) ABSTRACT

A method for achieving a high-resolution 3D reconstruction of a crystal, includes, vitrifying a sample of microcrystals for cryoTEM, recording a tilt series, and obtaining a first 3D reconstruction using the FB+COMET procedure. If the sample is of high quality, the repetitive structure and, if possible, the space group of the crystal are determined. If the space group could be determined, a second 3D reconstruction may be obtained including information about the space group.

### TECHNICAL FIELD OF THE INVENTION

The present invention relates to a method for achieving a high-resolution 3D reconstruction of a crystal as defined in the preamble of claim 1.

### BACKGROUND AND RELATED ART

For the study of proteins and other large molecules by X-ray or neutron crystallography, the macromolecules are often grown into crystals first. The crystals must be relatively large, typically in the order of magnitude of 10 μm. Such crystals are referred to as macrocrystals.

It is difficult to achieve crystals of the required size. Only a small amount of the proteins can be expected to yield crystals that can be grown into large crystals at all, and for those who can, the process involves a lot of trial and error.

The state of the art procedure for growing crystals is as follows:

A buffer solution of the molecule that is to be crystallized is placed in a petri dish, either as a hanging drop or as a sitting drop, surrounded by a similar solution having a higher concentration of e.g. salt. Because of the different concentrations, the solution in the hanging drop or sitting drop will then evaporate, causing a precipitation in the drop comprising a higher concentration of the molecule. The molecule may or may not have crystallized depending on the conditions. The conditions favouring crystallization are not the same for different types of molecules, which means that each type of molecule must be tried out individually.

Usually a large number of samples are made and placed under different conditions, for example, different surrounding solutions, low temperature, high temperature, varying temperature, varying pH and ionic strength, hoping that some of the conditions will be favourable for growing crystals. In subsequent steps conditions that lead to the formation of microcrystals (small crystals much less than about 10 micrometers) are adjusted and refined to obtain macrocrystals which can be used for imaging by X-ray and neutron crystallographic techniques.

The crystals formed range from very small to, in the best case, some that are large enough to be used. The samples that do not result in sufficiently large crystals, typically the majority of samples, are discarded.

### OBJECT OF THE INVENTION

Thus it is an object of the invention to enable the use of a larger fraction of the samples for imaging.

### SUMMARY OF THE INVENTION

This is achieved according to the invention by a method for achieving a high-resolution 3D reconstruction of a crystal, comprising the step of growing a crystal in a way known in the art characterized by the steps of
Crushing the crystal into microcrystals
Vitrifying a sample of the microcrystals for cryoTEM (Transmission Electron Microscopy)
Recording a tilt series
Obtaining a first 3D reconstruction using an iterative reconstruction method in which a prior prejudice distribution is refined in at least one step on the basis of a comparison with the collected image information

One such method would be to use filtered backprojection (FB) software, or some other fast procedure to get an initial estimate of the 3D structure, followed by an refinement procedure that will result in a high resolution 3D structure. Preferably, after the FB procedure the Comet technology, as described in the International Patent Application WO97/33255, hereby incorporated by reference, (corresponding European Patent Application EP 885 430 and Swedish Patent Application 9601229-9) is used for image reconstruction.

The Comet technology is based on the following steps:
An initial estimated distribution of the sample is provided
A blurred prior prejudice distribution is provided based on the estimated distribution
Observed data of the sample is provided

In an iterative process a calculating means calculates, for each iteration, a new estimated distribution of the sample using a comparison between the estimated distribution and the observed data of the sample. A new prior prejudice distribution less blurred than the previous one is also calculated.

The iterations are continued until the difference between the new estimated distribution and the next preceding estimated distribution is less than a predetermined condition.

If the sample is of high quality, the repetitive structure of the crystal and, if possible, the space group of the crystal is determined.

If the space group could be determined, the geometry is refined and a second 3D reconstruction, using a procedure as described above, for example the combination of filtered backprojection and COMET, is obtained including information about the space group.

If the space group could not be determined, perform correlation averaging on the sample.

Information about the quality of the sample can also be used as feedback for the process of growing crystals.

The method according to the invention enables the use of microcrystals for achieving 3D reconstructions with a very high resolution, in the order of magnitude of 10 Å.

This in turn means that such 3D reconstructions can be made for molecules that cannot be imaged by X-ray or neutron crystallographic techniques today because it has been impossible to grow large enough crystals for state of the art methods. Only a small amount of the macromolecules cannot be grown to microcrystals. In contrast, as mentioned above, only a minor portion can be grown to macrocrystals.

A major advantage of the method is that molecules that have been modified can be identified and analyzed. Generally, even if a molecule can be crystallized, a small modification such as the addition of a ligand can make it difficult or impossible to crystallize it into macrocrystals. Studies of how ligands are bound to a certain protein are of great interest to protein chemists and with the inventive method this can be studied down to the level of which amino acid the ligand is bound to. The structures can also be compared to protein structures that have already been determined. With the inventive method, therefore, a more flexible handling of ligands is enabled.

The inventive method will also enable 3D reconstructions to be made of entirely new types of molecules, like proteoglycans.

### BRIEF DESCRIPTION OF THE DRAWING

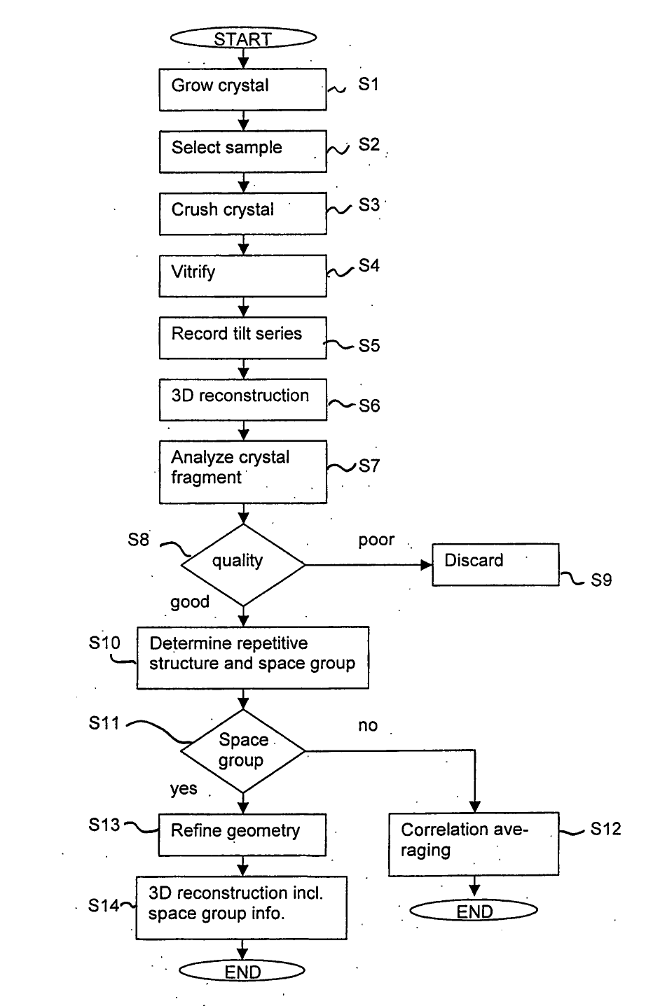

In the following the invention will be described in more detail, with reference to the appended FIG. 1, which is an overall flow chart of the inventive method.

### DETAILED DESCRIPTION

According to the invention, when the preparatory process to grow crystals (S1) described initially is over, first the samples are examined to see which ones are likely to have any crystals at all. This can be done by looking at them, first with the bare eye or with a light microscope, then for example through a Transmission Electron Microscope (TEM).

A sample that comprises crystals is selected (S2) and treated as follows:

First it is subjected to a process, for example spinning (S3), to crush the crystals into very small crystals, microcrystals, in the order of magnitude of 100 nm. These microcrystals can be treated in the same way as for proteins in a solution to vitrify them for cryo-TEM (S4), that is
Place a thin film of the solution comprising the microcrystals on a grid and plunge-freeze it
Record a standard cryo-TEM tilt series for the ensuing 3D reconstruction. Align with, for example, gold markers

Generate a 3D reconstruction (S6) using an iterative reconstruction method in which a prior prejudice distribution is refined in at least one step on the basis of a comparison with the collected image information, for example the combination of filtered backprojection and COMET as discussed above. This involves first taking a back-projection or getting an estimate of the structure in an alternative way before imaging using the iterative method. This results in information about the structure of the crystal fragment.

Next the crystal fragment is identified and analyzed (S7). If it is of poor quality it is discarded (S9) and the process starts again with another sample. The information that the sample is of poor quality can be used as feedback to exclude the conditions under which the sample was placed, and which were not good for growing crystals.

If the crystal fragment is of good quality, the procedure continues as follows: The information about the sample quality can be used as feedback to adjust the conditions used to grow it so that larger crystals can be grown.

More importantly for the inventive process, the repetitive structure of the crystal is determined and its space group, if possible (S10).

If the space group cannot be determined correlation averaging is performed (S12) on the repetitive fragments and the regularity of the lattice of the crystal is estimated. This enables an assessment of the quality and also preliminary information about the 3D structure.

If the space group can be determined the process continues as follows:

The geometry of the space group is refined, and its orientation is determined (S13). Imaging (S14) using the methods as discussed above including space group symmetry. This results in a 3D reconstruction having a very high resolution, probably of the same order of magnitude as what can be achieved for macrocrystals using prior art methods. How to do this for an icosahedral structure has already been described in the International Patent Application WO97/33255, hereby incorporated by reference, (corresponding European Patent Application EP 885 430 and Swedish Patent Application 9601229-9). All symmetry groups, crystallographic as well as non-crystallographic can be readily implemented in the COMET procedure using the methods disclosed in this document since it only concerns averaging of the gradient maps in the search directions. In the example given in the reference the icosahedral symmetry was used in the refinement of the adenovirus structure by averaging the two search directions of the 3D gradient density maps of the chi-square and entropy functions. The averaging then precisely followed the specification for the specified symmetry group. The skilled person will realize that the COMET procedure can be applied to any kind of symmetry operator and should be implemented in an analogous way to the example referred to above.

1-5. (canceled)

6. A method for achieving a high-resolution 3D reconstruction of a crystal, comprising the step of growing a crystal in a way known in the art characterized by the steps of
Vitrifying a sample of the microcrystals for cryoTEM
Recording a tilt series
Obtaining a first 3D reconstruction using an iterative reconstruction method in which a prior prejudice distribution is refined in at least one step on the basis of a comparison with the collected image information.

7. A method according to claim 6, further comprising the step of crushing the crystal into microcrystals.

8. A method according to claim 6, wherein the iterative reconstruction method is the a filtered backprojection followed by the COMET procedure.

9. A method according to claim 8, further comprising the step of:
if the sample is of high quality, determining the repetitive structure of the crystal and, if possible, the space group of the crystal.

10. A method according to claim 9, further comprising the following steps:
If the space group could be determined, refine the geometry and obtain a second 3D reconstruction including information about the space group.

11. A method according to claim 10, further comprising the following step:
if the space group could not be determined, perform correlation averaging on the sample.

12. A method according to claim 7, wherein the iterative reconstruction method is the a filtered backprojection followed by the COMET procedure.

13. A method according to claim 12, further comprising the step of:
if the sample is of high quality, determining the repetitive structure of the crystal and, if possible, the space group of the crystal.
